(19) United States
(12) Patent Application Publication
(10) Pub. No.: US 2026/0154281 A1
(43) Pub. Date: Jun. 4, 2026

(54) INFORMATION QUERY METHOD AND APPARATUS, AND COMPUTER-READABLE STORAGE MEDIUM

(71) Applicant: Beijing Zitiao Network Technology Co., Ltd., Haidian District, Beijing (CN)

(72) Inventor: Feng CHEN, Beijing (CN)

(21) Appl. No.: 19/125,404

(22) PCT Filed: Jul. 31, 2024
(86) PCT No.: PCT/CN2024/108790

§ 371 Date: Apr. 29, 2025

(51) Int. Cl. G06F 16/2458

(52) U.S. Cl. CPC G06F 16/2477

(57) ABSTRACT

The present disclosure relates to an information query method and apparatus, and a computer-readable storage medium, and relates to the field of computer technologies. The information query method includes: generating, based on relative time information included in first information, second information including absolute time information and corresponding to the first information, where the relative time information and the absolute time information indicate a same time point; determining, based on time information in a first query request, related information of the first query request from the second information; and determining a query result based on the first information corresponding to the related information.

### TECHNICAL FIELD

The present disclosure relates to the field of computer technologies, and in particular, to an information query method, an information query apparatus, a computer-readable storage medium, and a computer program product.

### BACKGROUND

In many application scenarios of computer technologies, it is often required to query stored content based on time information. For example, recall and retrieval based on time information included in meeting recordings, personal entry information, etc. are common service scenarios.

In the related art, it is required to accurately retrieve related information of a time interval mentioned in a query request to include the related information in a query result.

### SUMMARY

According to some embodiments of the present disclosure, an information query method is provided. The method includes: generating, based on relative time information included in first information, second information including absolute time information and corresponding to the first information, where the relative time information and the absolute time information indicate a same time point; determining, based on time information in a first query request, related information of the first query request from the second information; and determining a query result based on the first information corresponding to the related information.

In some embodiments, the generating, based on relative time information included in the first information, the second information including the absolute time information and corresponding to the first information includes: determining the absolute time information based on a generation time of the first information and the relative time information.

In some embodiments, the generating, based on the relative time information included in first information, the second information including the absolute time information and corresponding to the first information includes: generating the second information based on the first information by using a first machine learning model.

In some embodiments, the generating, based on the relative time information included in the first information, the second information including the absolute time information and corresponding to the first information includes: selecting time-related content from the first information; determining, by using a second machine learning model, whether the time-related content includes the relative time information; and generating the second information in response to the time-related content including the relative time information.

In some embodiments, the selecting the time-related content from the first information includes: selecting, from the first information by using a word list, the time-related content including a designated keyword.

In some embodiments, the determining, based on the time information in the first query request, the related information of the first query request from the second information includes: generating a second query request including the absolute time information based on the relative time information included in the first query request; and determining the related information based on the second query request.

In some embodiments, the determining the related information based on the second query request includes: determining the related information based on a keyword in the second query request and a feature vector of the second query request.

In some embodiments, the determining a query result based on the first information corresponding to the related information includes: generating the query result based on the first information corresponding to the related information by using a third machine learning model.

According to other embodiments of the present disclosure, there is provided an information query apparatus. The apparatus includes: a generation unit configured to generate, based on relative time information included in first information, second information including absolute time information and corresponding to the first information, where the relative time information and the absolute time information indicate a same time point; a query unit configured to determine, based on time information in a first query request, related information of the first query request from the second information; and a determination unit configured to determine a query result based on the first information corresponding to the related information.

In some embodiments, the generation unit is configured to determine the absolute time information based on a generation time of the first information and the relative time information.

In some embodiments, the generation unit is configured to generate the second information based on the first information by using a first machine learning model.

In some embodiments, the generation unit is configured to select time-related content from the first information; determine, by using a second machine learning model, whether the time-related content includes the relative time information; and generate the second information in response to the time-related content including the relative time information.

In some embodiments, the generation unit is configured to select, from the first information by using a word list, the time-related content including a designated keyword.

In some embodiments, the query unit is configured to generate a second query request including the absolute time information based on the relative time information included in the first query request; and determine the related information based on the second query request.

In some embodiments, the query unit is configured to determine the related information based on a keyword in the second query request and a feature vector of the second query request.

In some embodiments, the query unit is configured to generate the query result based on the first information corresponding to the related information by using a third machine learning model.

According to still other embodiments of the present disclosure, an information query apparatus is provided. The apparatus includes: a memory; and a processor coupled to the memory, where the processor is configured to carry out an information query method according to any one of the above embodiments based on instructions stored in the memory.

According to yet other embodiments of the present disclosure, a computer-readable storage medium is provided. stored thereon a computer program that, when executed by a processor, carries out an information query method according to any one of the above embodiments.

According to still yet other embodiments of the present disclosure, a computer program product is further provided. The computer program product includes instructions that, when executed by a processor, cause the processor to carry out an information query method according to any one of the above embodiments.

From the following detailed description of exemplary embodiments of the present disclosure with reference to the accompanying drawings, other features and advantages of the present disclosure will become clear.

### BRIEF DESCRIPTION OF THE DRAWINGS

The accompanying drawings illustrated here are used to provide a further understanding of the present disclosure and constitute a part of the present application, and the illustrative embodiments of the present disclosure and the description thereof are used to explain the present disclosure and do not constitute improper limitations on the present disclosure. In the figures:

FIG. 1 is a flowchart of an information query method according to some embodiments of the present disclosure;

FIG. 2 is a flowchart of an information query method according to some other embodiments of the present disclosure;

FIG. 3 is a flowchart of an information query method according to still other embodiments of the present disclosure;

FIG. 4 is a block diagram of an information query apparatus according to some embodiments of the present disclosure;

FIG. 5 is a block diagram of an information query apparatus according to some other embodiments of the present disclosure; and

FIG. 6 is a block diagram of an information query apparatus according to still other embodiments of the present disclosure.

### DETAILED DESCRIPTION

The technical solutions in the embodiments of the present disclosure are clearly and completely described below with reference to the accompanying drawings of the embodiments of the present disclosure. However, apparently, the embodiments described are merely some embodiments of the present disclosure rather than all the embodiments. The following description of at least one exemplary embodiment is actually illustrative only, and in no way serves as any limitation to the present disclosure and application or use thereof. All other embodiments obtained by those of ordinary skill in the art based on the embodiments of the present disclosure without any creative effort shall fall within the scope of protection of the present disclosure.

Unless specifically stated otherwise, the relative arrangement of components and steps, numerical expressions, and numerical values set forth in these embodiments do not limit the scope of the present disclosure. Also, it should be understood that, for ease of description, the sizes of various parts shown in the drawings are not drawn to actual scale. Technologies, methods, and devices known to those skilled in the art may not be discussed in detail, but where appropriate, such technologies, methods, and devices should be considered as part of the authorized specification. In all examples shown and discussed here, any specific value should be interpreted as merely illustrative and not as limitations. Therefore, there may be different values in other examples of an exemplary embodiment. It should be noted that similar reference signs and letters refer to similar items in the following accompanying drawings. Therefore, once a specific item is defined in one of the accompanying drawings, it need not be further discussed in subsequent accompanying drawings.

As mentioned above, the retrieval based on the time interval mentioned in the query request can query for only content including absolute time information, but cannot query for content including relative time information.

For example, for a meeting held at a time point, meeting minute information “Today (20XX-6-18), the meeting mentioned the technical proposal review for project xx we conducted last Tuesday, and we planned to complete development by the first week of next month and could submit the project for testing” is entered. At the end of June, for the meeting minute information, a user initiates a query request “What technical proposal reviews we had at the beginning of this month?” or “What are the delivery plans for next month?”.

As can be seen, such query requests include an ambiguous time range query, that is, an information query based on relative time information, for which it is difficult to find accurate content in the related art.

The inventors of the present disclosure have found that there is the following problem in the above related art: the query result has low accuracy. In view of this, the present disclosure proposes a technical solution for information query, which can improve the accuracy of a query result.

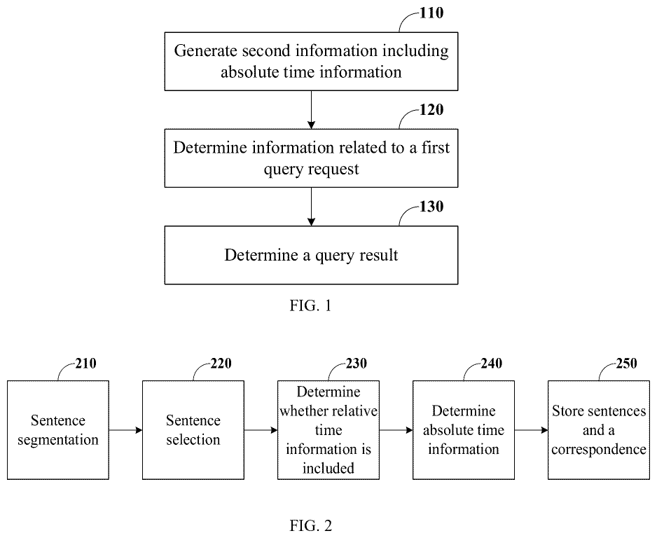

FIG. 1 is a flowchart of an information query method according to some embodiments of the present disclosure.

As shown in FIG. 1, the method includes the following steps. Step 110: Generate, based on relative time information included in first information, second information including absolute time information and corresponding to the first information, where the relative time information and the absolute time information indicate a same time point. For example, the first information may include text information, speech information, video information, etc.

For example, the relative time information may include time information indicating a target time point by a time interval from a designated time point, such as “last week,” “next month,” and “two hours ago”. The absolute time information may include a determined time point, such as “on x, x” and “at x:x”.

Step 120: Determine, based on time information in a first query request, related information of the first query request from the second information.

For example, the first information and the second information generated based on the first information may be determined to have a correspondence, and stored after being associated.

Step 130: Determine a query result based on the first information corresponding to the related information.

For example, by determining in step 120 that a piece of second information is the related information of the first query request, the first information corresponding to the second information may be determined based on the correspondence between the first information and the second information stored in advance.

In the above embodiments, the first information including the relative time information is converted into the second information including the absolute time information as a query basis, and the first information meeting the query request is found based on the correspondence between the first information and the second information. In this way, even if the relative time information is included in the information, a query result can still be accurately obtained, thereby improving the accuracy.

The method of generating the second information including the absolute time information is exemplified below through some embodiments.

In some embodiments, the absolute time information is determined based on a generation time of the first information and the relative time information. For example, the generation time of the first information (such as an entry time of a meeting minute and a creation time of a file in which the first information resides) may be recorded as a time base point of the relative time information. The time base point is added to or subtracted from the relative time information in the first information to calculate the absolute time information.

For example, on June 18, 20XX, the user enters a meeting minute “In the technical proposal review of project xx we conducted on the Tuesday before last, we planned to complete development by the first week of next month and could submit the project for testing” as first information. The first information has a generation time of June 18, 20XX, and includes relative time information “the Tuesday before last” and “the first week of next month”. It may be determined that absolute time information corresponding to “the Tuesday before last” is June 4, 20XX, and absolute time information corresponding to “the first week of next month” is July 1, 20XX to July 7, 20XX.

In this way, the relative time information can be converted into the absolute time information as a query basis, so that the query result can be accurately obtained.

In some embodiments, the second information is generated based on the first information by using a first machine learning model. For example, after the absolute time information is obtained, the second information including the absolute time information may be regenerated by artificial intelligence.

For example, the first information “In the technical proposal review of project xx we conducted on the Tuesday before last, we planned to complete development by the first week of next month and could submit the project for testing” including the relative time information “the Tuesday before last” and “the first week of next month” may be input into a machine learning model, and is rewritten into the second information “In the technical proposal review of project xx we conducted on June 4, 20XX, we planned to complete development by the week from July 1, 20XX to July 7, 20XX and could submit the project for testing” including the absolute time information “June 4, 20XX” and “from July 1, 20XX to July 7, 20XX”.

In this way, the rewriting of information by artificial intelligence can make the expression of the second information including the absolute time information more accurate, thereby improving the accuracy of the query by using this as a query basis.

The method of performing selection on the first information before generating the second information is exemplified below through some embodiments.

In some embodiments, time-related content is selected from the first information; whether the time-related content includes the relative time information is determined by using a second machine learning model; and the second information is generated in response to the time-related content including the relative time information. For example, the content including a designated keyword is selected from the first information by using a word list.

For example, the first information may include text information, speech information, video information, etc. In response to the first information being text information, the text information may be first segmented into sentences, and selection may be performed on the sentences. In response to the first information being speech information, the speech information may be segmented to obtain speeches of sentences, and selection may be performed on the speeches of the sentences. In response to the first information being speech information, speech recognition may also be performed on the speech information to obtain a speech recognition result, then the speech recognition result may be segmented into sentences, and selection may be performed on the sentences. In response to the first information being video information, speech information in the video information may be segmented to obtain speeches of sentences, and selection may be performed on the speeches of the sentences. In response to the first information being video information, speech recognition may also be performed on speech information in the video information to obtain a speech recognition result, then the speech recognition result may be segmented into sentences, and selection may be performed on the sentences.

For example, first, the first information may be segmented to obtain a plurality of sentences. Time-related sentences in the plurality of sentences may then be selected as candidate content by using the word list. For example, a sentence including a designated keyword related to a time point, such as date, day, month, and week, may be selected as the candidate content.

In this way, the amount of information that is converted into the absolute time information can be reduced, thereby improving the efficiency of the query and reducing costs.

For example, a second machine learning model that is smaller in size than the first machine learning model and a third machine learning model may be used to determine whether the candidate content includes the relative time information. The time-related content including the relative time information is used as an object for absolute time information conversion.

In this way, content including a time-related designated keyword (such as “make progress every day”) but not including relative time information can be removed, thereby improving the efficiency of the query and reducing costs.

A method for determining related information of a first query request is exemplified below through some embodiments.

In some embodiments, a second query request including the absolute time information is generated based on the relative time information included in the first query request; and the related information is determined based on the second query request. For example, the absolute time information may be determined based on a generation time of the first query request and the relative time information therein. For example, the generation time of the first query request may be used as a time base point of the relative time information. The time base point is added to or subtracted from the relative time information to calculate the absolute time information.

For example, the user initiates a first query request “What technical proposal reviews we had at the beginning of this month?” at the end of June, 20XX. The first query request has a generation time of the end of June, 20XX, and includes relative time information “the beginning of this month”. It may be determined that absolute time information corresponding to “the beginning of this month” is “from June 1, 20XX to June 10, 20XX”.

In this way, the relative time information in the query request can be converted into the absolute time information, thereby improving the accuracy of the query.

In some embodiments, the second query request is generated by using the first machine learning model based on the first query request. For example, after the absolute time information is obtained, the second query request including the absolute time information may be regenerated by artificial intelligence.

For example, the first query request “What technical proposal reviews we had at the beginning of this month?” including the relative time information “the beginning of this month” may be input into the machine learning model, and is rewritten into the second query request “What technical proposal reviews we had from June 1, 20XX to June 10, 20XX?” including the absolute time information “from June 1, 20XX to June 10, 20XX”.

In this way, the rewriting of information by artificial intelligence can make the expression of the second query request including the absolute time information more accurate, thereby improving the accuracy of the query.

In some embodiments, the related information is determined based on a keyword in the second query request and a feature vector of the second query request. For example, a similarity query may be made based on the keyword and feature vector in the second query request and keywords and feature vectors of various pieces of the second information, and the second information that is most similar to the second query request may be determined as the related information.

For example, in combination with keywords and feature vectors, a plurality of pieces of related information may be determined as bases for determining the query result.

In this way, the query is made in combination with keywords and feature vectors to realize multi-way recall of the query request, thereby improving the accuracy of the query.

A method for determining the query result is exemplified below through some embodiments.

In some embodiments, the query result is generated by using the third machine learning model based on the first information corresponding to the related information. For example, reply information corresponding to the query request may be generated by artificial intelligence based on the first information corresponding to the related information.

For example, the first machine learning model and the third machine learning model may be the same machine learning model, or may be two different machine learning models.

In the above embodiments, the first information including the relative time information is converted into the second information including the absolute time information as a query basis, and the first information meeting the query request is found based on the correspondence between the first information and the second information. In this way, even if the relative time information is included in the information, the query result can still be accurately obtained, thereby improving the accuracy.

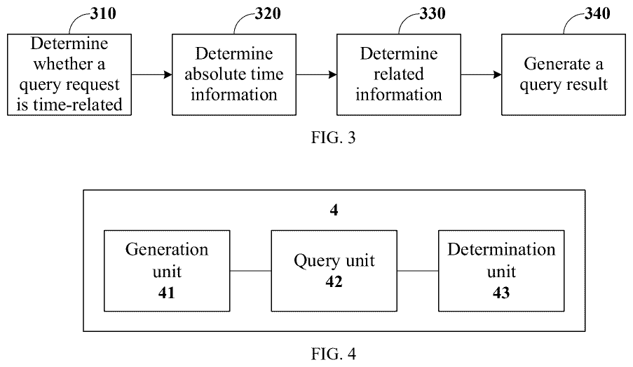

The information query method of the present disclosure is exemplified below in combination with some embodiments in FIG. 2 and FIG. 3.

FIG. 2 is a flowchart of an information query method according to some other embodiments of the present disclosure.

As shown in FIG. 2, in a production phase of first information as a query object, two pieces of time information may be pre-processed during storage or embedding of information. A generation (such as entry) time of the first information is recorded as meta information; and relative time information mentioned in the first information is converted into absolute time information, and second information after conversion is recorded as mapping information or attribute information of the first information to store a correspondence between the first information and the second information. This may be implemented, for example, by the following steps.

Step 210: Segment the first information (that is, a source text to be queried) to obtain a plurality of sentences. For example, the generation time of the first information may be record as a time base point of the relative time information.

Subsequently, selection may be performed on the sentences by using the word list, the second machine learning model, etc. to reduce the number of sentences to be processed, thereby improving the query performance and reducing costs.

Step 220: Select time-related sentences in these sentences as candidate content by using the word list. For example, a sentence including a designated keyword related to a time point, such as date, day, month, and week, may be selected as the candidate content.

In this way, the amount of information that is converted into absolute time information can be reduced, thereby improving the efficiency of the query and reducing costs.

Step 230: Determine whether the candidate content includes the relative time information by using the second machine learning model that is smaller in size than the first machine learning model and the third machine learning model. The candidate content including the relative time information is used as an object for absolute time information conversion.

In this way, content including a time-related designated keyword (such as “make progress every day”) but not including relative time information can be removed, thereby improving the efficiency of the query and reducing costs.

Step 240: Determine, by using the first machine learning model, the absolute time information corresponding to the relative time information and generate the second information (that is, a rewritten sentence).

In this way, the rewriting of information by artificial intelligence can make the expression of the second information including the absolute time information more accurate, thereby improving the accuracy of the query by using this as a query basis.

Step 250: Put the second information generated and the first information corresponding to the second information into storage, and establish a correspondence between the first information and the second information.

In this way, the relative time information can be converted into the absolute time information as a query basis, so that the query result can be accurately obtained.

In the above embodiments, the first information including the relative time information is converted into the second information including the absolute time information as a query basis, and the first information meeting the query request is found based on the correspondence between the first information and the second information. In this way, even if the relative time information is included in the information, a query result can still be accurately obtained, thereby improving the accuracy.

FIG. 3 is a flowchart of an information query method according to still other embodiments of the present disclosure.

As shown in FIG. 3, in a consumption phase of first information as a query object, in response to a query request of a user involving time-related content, relative time information is rewritten into absolute time information, and then a similarity query is made based on second information to determine recall content of this query; the recall content is sent to a third machine learning model for processing; and the saved first information is returned to the user after the processing is complete. This may be implemented, for example, by the following steps.

Step 310: Determine whether a first query request is time-related.

Step 320: Rewrite, in response to the first query request being time-related and including the relative time information, the relative time information into the absolute time information to generate a second query request.

In this way, the relative time information in the query request can be converted into the absolute time information, thereby improving the accuracy of the query. The rewriting of information by artificial intelligence can make the expression of the second query request including the absolute time information more accurate, thereby improving the accuracy of the query.

Step 330: Perform, by using the second query request including the absolute time information, multi-way recall processing including feature vector recall and keyword recall to determine related information of the first query request.

In this way, the query is made in combination with keywords and feature vectors to realize multi-way recall of the query request, thereby improving the accuracy of the query.

Step 340: Send the related information of the first query request to the third machine learning model for uniform processing and then return the related information after the uniform processing to the user. For example, the multi-way recall may recall related second information based on the time information mentioned by the user, and return the first information corresponding to the second information to the user.

In the above embodiments, the first information including the relative time information is converted into the second information including the absolute time information as a query basis, and the first information meeting the query request is found based on the correspondence between the first information and the second information. In this way, even if the relative time information is included in the information, a query result can still be accurately obtained, thereby improving the accuracy.

FIG. 4 is a block diagram of an information query apparatus according to some embodiments of the present disclosure.

As shown in FIG. 4, the information query apparatus 4 includes: a generation unit 41 configured to generate, based on relative time information included in first information, second information including absolute time information and corresponding to the first information, where the relative time information and the absolute time information indicate a same time point; a query unit 42 configured to determine, based on time information in a first query request, related information of the first query request from the second information; and a determination unit 43 configured to determine a query result based on the first information corresponding to the related information.

In some embodiments, the generation unit 41 is configured to determine the absolute time information based on a generation time of the first information and the relative time information.

In some embodiments, the generation unit 41 is configured to generate the second information based on the first information by using a first machine learning model.

In some embodiments, the generation unit 41 is configured to select time-related content from the first information; determine, by using a second machine learning model, whether the time-related content includes the relative time information; and generate the second information in response to the time-related content including the relative time information.

In some embodiments, the generation unit 41 is configured to select, from the first information by using a word list, the time-related content including a designated keyword.

In some embodiments, the query unit 42 is configured to generate a second query request including the absolute time information based on the relative time information included in the first query request; and determine the related information based on the second query request.

In some embodiments, the query unit 42 is configured to determine the related information based on a keyword in the second query request and a feature vector of the second query request.

In some embodiments, the query unit 42 is configured to generate the query result based on the first information corresponding to the related information by using a third machine learning model.

In the above embodiments, the first information including the relative time information is converted into the second information including the absolute time information as a query basis, and the first information meeting the query request is found based on the correspondence between the first information and the second information. In this way, even if the relative time information is included in the information, a query result can still be accurately obtained, thereby improving the accuracy.

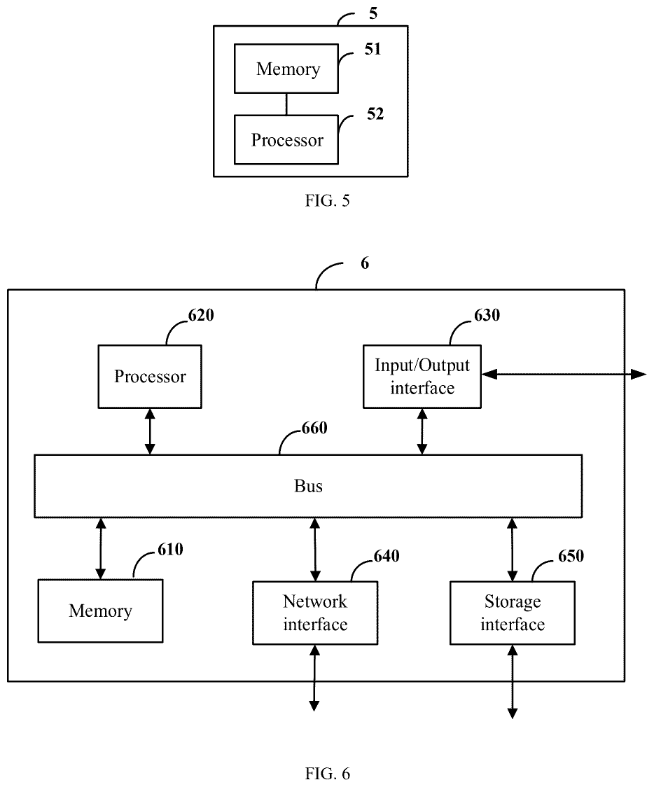

FIG. 5 is a block diagram of an information query apparatus according to some other embodiments of the present disclosure.

As shown in FIG. 5, the information query apparatus 5 in the embodiments includes: a memory 51 and a processor 52 coupled to the memory 51, where the processor 52 is configured to carry out an information query method according to any one of the embodiments of the present disclosure based on instructions stored in the memory 51.

The memory 51 may include, for example, a system memory, a fixed non-volatile storage medium, etc. The system memory stores, for example, an operating system, an application, a boot loader, a database, and other programs.

FIG. 6 is a block diagram of an information query apparatus according to still other embodiments of the present disclosure.

As shown in FIG. 6, the information query apparatus 6 in the embodiments includes: a memory 610 and a processor 620 coupled to the memory 610, where the processor 620 is configured to carry out an information query method according to any one of the above embodiments based on instructions stored in the memory 610.

The memory 610 may include, for example, a system memory, a fixed non-volatile storage medium, etc. The system memory stores, for example, an operating system, an application, a boot loader, and other programs.

The apparatus 6 may also include an input/output interface 630, a network interface 640, a storage interface 650, etc. These interfaces 630, 640, and 650, and the memory 610 and the processor 620 may be connected to each other via a bus 660, for example. The input/output interface 630 provides a connection interface for an input/output device such as a display, a mouse, a keyboard, a touch screen, a microphone, and a loudspeaker box. The network interface 640 provides a connection interface for various networking devices. The storage interface 650 provides a connection interface for an external storage device such as an SD card and a USB flash drive.

It should be understood by those skilled in the art that the embodiments of the present disclosure can be provided as a method, a system, or a computer program product. Accordingly, the present disclosure may take a form of an entirely hardware embodiment, an entirely software embodiment, or an embodiment combining software and hardware aspects. Furthermore, the present disclosure may take the form of a computer program product that is implemented on one or more computer-usable non-transitory storage media (including, but not limited to, a disk memory, a CD-ROM, an optical memory, etc.) that include computer-usable program code.

So far, the present disclosure has been described in detail. In order to avoid obscuring the concept of the present disclosure, some details well known in the art are not described. Based on the above description, those skilled in the art can fully understand how to implement the technical solutions disclosed here.

The method and system of the present disclosure may be implemented in many ways. For example, the method and system of the present disclosure may be implemented in software, hardware, firmware, or any combination of software, hardware, and firmware. The above order of the steps of the method is only for illustration, and unless otherwise specifically stated, the steps of the method of the present disclosure are not limited to the order specifically described above. In addition, in some embodiments, the present disclosure may also be implemented as a program recorded in a recording medium, where the program includes machine-readable instructions for implementing the method according to the present disclosure. Therefore, the present disclosure also covers a recording medium storing a program for executing the method according to the present disclosure.

While some specific embodiments of the present disclosure have been exemplarily described in detail, it should be understood by those skilled in the art that the above examples are merely for illustration and are not intended to limit the scope of the present disclosure. Those skilled in the art should understand that various modifications can be made to the above embodiments, without departing from the scope and spirit of the present disclosure. The scope of the present disclosure is defined by the appended claims.

1. An information query method, comprising:
generating, based on relative time information comprised in first information, second information comprising absolute time information and corresponding to the first information, wherein the relative time information and the absolute time information indicate a same time point;
determining, based on time information in a first query request, related information of the first query request from the second information; and
determining a query result based on the first information corresponding to the related information.

2. The information query method according to claim 1, wherein the generating, based on the relative time information comprised in the first information, the second information comprising the absolute time information and corresponding to the first information comprises:
determining the absolute time information based on a generation time of the first information and the relative time information.

3. The information query method according to claim 1, wherein the generating, based on the relative time information comprised in the first information, the second information comprising the absolute time information and corresponding to the first information comprises:
generating the second information based on the first information by using a first machine learning model.

4. The information query method according to claim 1, wherein the generating, based on the relative time information comprised in the first information, the second information comprising the absolute time information and corresponding to the first information comprises:
selecting time-related content from the first information;
determining, by using a second machine learning model, whether the time-related content comprises the relative time information; and
generating the second information in response to the time-related content comprising the relative time information.

5. The information query method according to claim 4, wherein the selecting the time-related content from the first information comprises:
selecting, from the first information by using a word list, the time-related content comprising a designated keyword.

6. The information query method according to claim 1, wherein the determining, based on the time information in the first query request, the related information of the first query request from the second information comprises:
generating a second query request comprising the absolute time information based on the relative time information comprised in the first query request; and
determining the related information based on the second query request.

7. The information query method according to claim 6, wherein the determining the related information based on the second query request comprises:
determining the related information based on a keyword in the second query request and a feature vector of the second query request.

8. The information query method according to claim 1, wherein the determining the query result based on the first information corresponding to the related information comprises:
generating the query result based on the first information corresponding to the related information by using a third machine learning model.

9. (canceled)

10. An information query apparatus, comprising:
a memory; and
a processor coupled to the memory, wherein the processor is configured to carry out an information query method comprising:
generating, based on relative time information comprised in first information, second information comprising absolute time information and corresponding to the first information, wherein the relative time information and the absolute time information indicate a same time point;
determining, based on time information in a first query request, related information of the first query request from the second information; and
determining a query result based on the first information corresponding to the related information.

11. A non-transitory computer-readable storage medium stored thereon a computer program that, when executed by a processor, carries out an information query method comprising:
generating, based on relative time information comprised in first information, second information comprising absolute time information and corresponding to the first information, wherein the relative time information and the absolute time information indicate a same time point;
determining, based on time information in a first query request, related information of the first query request from the second information; and
determining a query result based on the first information corresponding to the related information.

12. (canceled)

13. The information query apparatus according to claim 10, wherein the processor carries out a following step:
determining the absolute time information based on a generation time of the first information and the relative time information.

14. The information query apparatus according to claim 10, wherein the processor carries out a following step:
generating the second information based on the first information by using a first machine learning model.

15. The information query apparatus according to claim 10, wherein the processor carries out following steps:
selecting time-related content from the first information;
determining, by using a second machine learning model, whether the time-related content comprises the relative time information; and
generating the second information in response to the time-related content comprising the relative time information.

16. The information query apparatus according to claim 15, wherein the processor carries out a following step:
selecting, from the first information by using a word list, the time-related content comprising a designated keyword.

17. The information query apparatus according to claim 10, wherein the processor carries out following steps:
generating a second query request comprising the absolute time information based on the relative time information comprised in the first query request; and
determining the related information based on the second query request.

18. The information query apparatus according to claim 17, wherein the processor carries out a following step:
determining the related information based on a keyword in the second query request and a feature vector of the second query request.

19. The information query apparatus according to claim 10, wherein the processor carries out a following step:
generating the query result based on the first information corresponding to the related information by using a third machine learning model.
